(19) United States
(12) Patent Application Publication
(10) Pub. No.: US 2017/0292679 A1
(43) Pub. Date: Oct. 12, 2017

(54) LIGHT-EMITTING DEVICE

(71) Applicant: SHIMADZU CORPORATION, Kyoto-shi (JP)

(72) Inventor: Jiro SAIKAWA, Kyoto (JP)

(73) Assignee: SHIMADZU CORPORATION, Kyoto-shi (JP)

(21) Appl. No.: 15/091,804

(22) Filed: Apr. 6, 2016

(51) Int. Cl. F21V 13/12; G02B 19/00; F21V 13/02

(52) U.S. Cl. CPC F21V 13/12; F21V 13/02; G02B 19/0052

(57) ABSTRACT

A light-emitting device for increasing power by combining beams from a plurality of light sources and for improving focusing performance including a plurality of light sources; and a light-outputting device for generating collimated beams for respective emitted lights from the plurality of light sources and for outputting enlarged beams wherein the beam diameters of the respective collimated beams have been enlarged in the direction wherein the beam diameters are small.

### TECHNICAL FIELD

The present invention relates to a light-emitting device that combines and outputs light from a plurality of light sources

### BACKGROUND ART

Light-emitting devices that cause light, wherein light from a plurality of light sources is combined, in order to increase power, or the like, to be incident onto a light receiving device, such as an optical fiber, or the like, have been proposed (referencing, for example, Patent Documents 1 through 3). These light-emitting devices employ methods such as using light-emitting diodes (LEDs) or semiconductor lasers, or the like, as the light sources, and using lenses or prisms to combine the lights from each of the individual light sources.

### PRIOR ART DOCUMENTS

### Patent Documents

Patent Document 1: Japanese Patent 3228098

Patent Document 2: Japanese Unexamined Patent Application Publication 2008-60613

Patent Document 3: Japanese Patent 4188795

### SUMMARY OF THE INVENTION

### Problem Solved by the Present Invention

However, although when light from a plurality of light sources is combined, it increases the power, there has not been adequate research regarding technologies for improving focusing performance. For example, in the invention set forth in Patent Document 3, because the magnification rate in the direction in which the width of the light emission area is wide is limited by the magnification rate of the collimating lens and the focusing lens, there is a limit to the focusing performance, despite achieving an increase in power. Because of this, it is difficult to achieve increased brightness. The object of the present invention is to provide a light-emitting device that increases power, through combining light from a plurality of light sources, and that also improves the focusing performance.

### Means for Solving the Problem

In one aspect of the present invention, a light-emitting device is provided comprising: (I) a plurality of light sources; (II) a light-outputting device that produces a collimated beam from each of the emitted lights from the plurality of light sources, and that outputs an enlarged beam wherein the spaces between individual beams are narrowed and wherein the beam diameters are enlarged in the direction in which the beam diameters are small for each of the individual collimated beams; and (III) a focusing device for focusing the enlarged beams.

### Effects of the Invention

The present invention enables the provision of a light-emitting device that increases power through combining light from a plurality of light sources and improves the focusing performance.

### BRIEF DESCRIPTION OF DRAWINGS

FIG. 1 is a schematic diagram illustrating a structure for a light-emitting device according to a first embodiment according to the present invention.

FIG. 2 is a schematic diagram illustrating an example of a light source.

FIG. 3 is a schematic diagram illustrating a structure for a light-emitting device of a comparative example.

FIG. 4 is a schematic diagram for explaining the enlargement of the beam diameter in the light-emitting device according to the first embodiment according to the present invention.

FIG. 5 is a graph showing the characteristics of the light that is outputted in the comparative example.

FIG. 6 is a graph illustrating characteristics of the light that is outputted from the light-emitting device according to the first embodiment according to the present invention.

FIG. 7 is a schematic diagram illustrating the structure for a light-emitting device according to a modified example of the first embodiment according to the present invention.

FIG. 8 is a schematic perspective diagram illustrating a structure for a light-emitting device according to a second embodiment according to the present invention.

FIG. 9 is a schematic front view illustrating the structure of the light-emitting device according to the second embodiment according to the present invention.

FIG. 10 is a schematic plan view illustrating the structure of the light-emitting device according to the second embodiment according to the present invention.

FIG. 11 is a schematic side view illustrating the structure of the light-emitting device according to the second embodiment according to the present invention.

FIG. 12 is a schematic diagram illustrating a structure for a light-emitting device according to a modified example of the second embodiment according to the present invention.

FIG. 13 is a schematic diagram illustrating a structure for a light-emitting device according to another modified example of the second embodiment according to the present invention.

FIG. 14 is a schematic diagram illustrating a structure for a light-emitting device according to a third embodiment according to the present invention.

### DETAILED DESCRIPTION OF THE EXEMPLARY EMBODIMENTS

Embodiments according to the present invention will be explained in reference to the drawings. In the descriptions of the drawings below, identical or similar parts are assigned identical or similar reference symbols. It should be understood that the drawings are schematic. Moreover, the embodiments set forth below illustrate devices and methods for embodying the technical concepts in the present invention, and the structures, arrangements, and the like of structural components in embodiments of the present invention are not limited to those specified below. Embodiments of the present invention may be changed in a variety of ways within the scope of the patent claims.

### First Embodiment

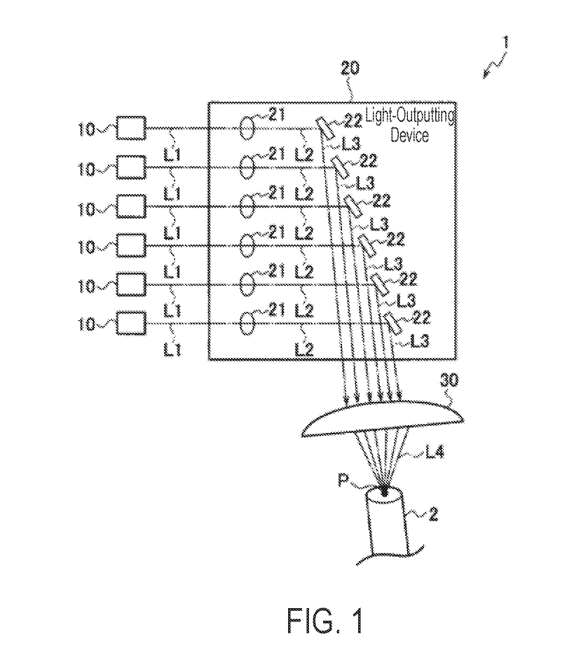

A light-emitting device 1 according to a first embodiment according to the present invention, as illustrated in FIG. 1, comprises: a plurality of light sources 10; a light-outputting device 20 for generating a collimated beam L2 for each of the emitted lights L1 from the plurality of light sources 10, and for outputting enlarged beams L3 wherein, for each of the collimated beams L2, the beam diameter in the direction in which the beam diameter is small is enlarged; and focusing devices 30 for focusing the enlarged beams L3.

In the example illustrated in FIG. 1, six light sources 10 are arrayed in a one-dimensional array along a given direction. Note that the number of light sources 10, of course, is not limited to 6. The light-emitting devices 1 focuses the emitted lights L1 that are emitted from the individual light sources 10, and causes the focused output lights L4 to be incident onto light receiving devices 2. The light receiving device 2 is, for example, an optical fiber, where the light-emitting device 1 focuses the emitted lights L1 onto the core portion of the optical fiber. The focusing devices 30 are, for example, focusing lenses.

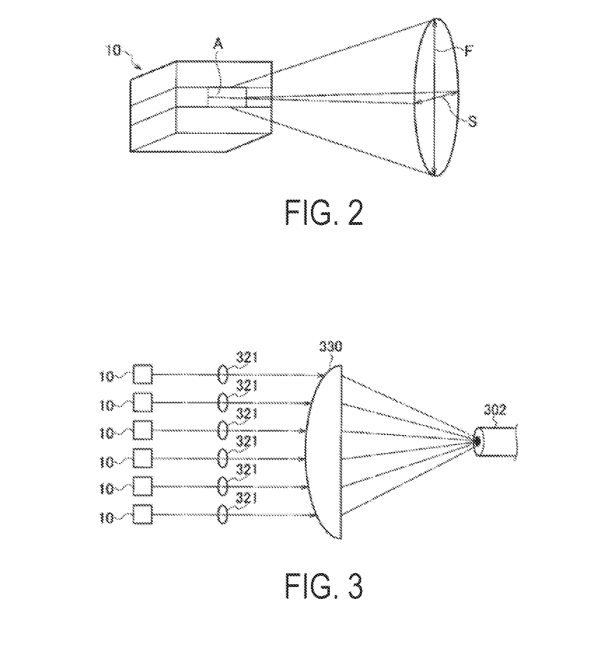

The light sources 10 are, for example, semiconductor lasers (LDs) or solid-state lasers. In these light sources 10, and, in particular, with semiconductor lasers, the cross-sectional shape of the emitted light, perpendicular to the direction in which the light advances (hereinafter termed the “advancing plane”) is elliptical. In the light emitted from an end-face output-type single emitter semiconductor laser, for example, the beam is spread widely in the direction in which the size of the light-emitting area (the emitter size) is small. That is, as illustrated in FIG. 2, the direction in which the size of the light-emitting area A is wide is the slow axial direction, and the direction in which the size of the light-emitting area is narrow is the first axial direction. As illustrated in FIG. 2, the shape of the advancing plane of the emitted light has a narrow beam width the direction in which the size of the light-emitting area is wide (the slow axial direction S), and the beam width in the direction wherein the size of the light-emitting area is narrow (the first axial direction F) is wide.

Because of this, when, as in the comparative example illustrated in FIG. 3, for example, the emitted lights from the light sources 10 is focused onto the core portion of an optical fiber 302 by a collimating lens 321 and a focusing lens 330, it is necessary to reduce the optical magnification rate m=f₁/f₂ that is determined by the focal point distance f₁ of the collimating lens 321 and the focal point distance f₂ of the focusing lens 330. However, in order to combine a greater number of beams, it is necessary to increase the effective diameter while preserving the numerical aperture NA of the focusing lens 330. The result is that the focal point distance f₂ becomes longer, so the focusing performance is limited, making it difficult to achieve an increased brightness.

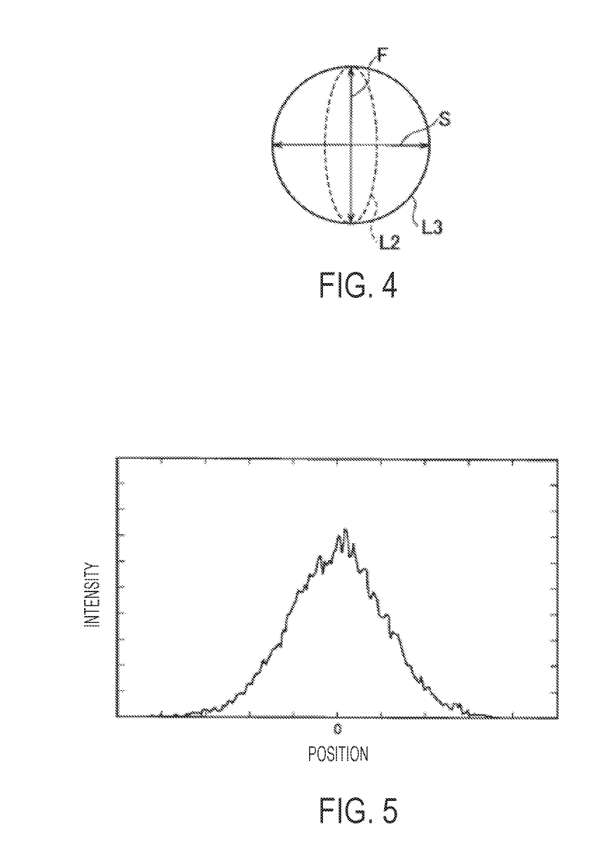

As illustrated in FIG. 4, in the light-emitting device 1, the beam diameters in the direction wherein the beam diameter is small (the slow axial direction S) is enlarged for the collimated beams L2 wherein the emitted lights L1 from the light sources 10 have been collimated. In the light-emitting device 1 illustrated in FIG. 1, the light-outputting device 20 is provided with collimating devices 21 for collimating the emitted lights L1, and diffraction gratings 22 for enlarging the beam diameters of the collimated beams L2.

The collimating devices 21 generate collimated beams L2 by collimating each of the emitted lights L1 from the plurality of light sources 10. The collimating devices 21 may employ, for example, collimating lenses, or the like. The collimating lenses are prepared one each for the respective emitted lights L1.

The diffraction gratings 22 output enlarged beams L3 wherein the beam diameters have been enlarged in the direction of the small beam diameter, as diffracted lights for each of the individual collimated beams L2 outputted from the collimating devices 21.

The number of grooves in the diffraction gratings 22, and the angles of incidence of the collimated beams L2 into the diffraction gratings 22, are set so that, for the collimated beams L2, the beam diameters are enlarged in the direction in which the beam diameter is small, and so that the diffracted lights, wherein the beam diameters have been enlarged, are outputted in a prescribed direction. That is, the beam diameters can be enlarged by increasing the angles of incidence formed between the direction that is normal to the incident faces of the diffraction gratings 22 on which the collimated beams L2 are incident and the directions in which the collimated beams L2 advance. Moreover, the angles of emission of the enlarged beams L3, which are outputted from the diffraction gratings 22, are set through combinations of the wavelengths of the collimated beams L2 and the numbers of grooves in the diffraction gratings 22.

Moreover, the positions of the diffraction gratings 22 and the emission angles of the enlarged beams L3 can be adjusted so that the distances between neighboring enlarged beams L3 will be smaller than the distances between the light sources 10. Doing so enables an improvement in the focusing performance of the output light L4. For example, the enlarged beams L3 can be outputted to the focusing devices 30 after the scope of the arrangement, in a direction perpendicular to the advancing direction of the plurality of enlarged beams L3 that are outputted from the light-outputting device 20 has been made narrower than the area of the region wherein the light sources 10 are arranged. That is, the density of the enlarged beams L3 on the focusing lenses can be increased.

Note that, preferably, the first-order diffracted light is used for the enlarged beams L3. Doing so enables the second-order diffracted light, and the like, to be used to narrow the spectrum of the enlarged beams L3. That is, a portion of the diffracted light that is generated by the diffraction grating 22, for example, the second-order diffracted light, is returned to the light source 10, to form a resonator between the light source 10 and the diffraction grating 22. The result is that the output light L4 has the spectrum thereof narrowed, making it possible to increase the output power. To do this, for example, the diffraction grating 22 is set so as to have a spatial frequency that returns the second-order diffracted light to the light source 10. This “spatial frequency” is the inverse of the period for placement of the grooves that form the incident face of the diffraction grating 22, the inverse of the number of grooves per 1 mm.

As described above, in the light-emitting device 1, enlarged beams L3, wherein the beam diameters in the direction wherein the beam diameters are small have been enlarged, are focused. Because of this, it is possible to reduce the optical magnification rate in the direction wherein the beam diameter is small to be less than the optical magnification rate that is determined by the collimating lens 321 and the focusing lens 330, shown in FIG. 3. That is, when compared to the case of focusing the collimated beam L2, as-is, the optical magnification rate can be set lower in the light-emitting device 1.

Consequently, with the light-emitting device 1, the area of the focusing spot P of the light that is focused by the focusing device 30 will be reduced. That is, this makes it possible to improve the focusing performance, to improve the brightness of the output lights L4 from the light-emitting device 1.

The output lights L4 that are focused by the focusing devices 30 is incident on to the light receiving device 2, such as an optical fiber, as illustrated in FIG. 1, for example. Because of the focusing performance of the output lights L4 is improved, the diameter of the core the optical fiber can be reduced. Because of this, it is possible to cause output lights L4 that have increased brightness to propagate within the optical fiber.

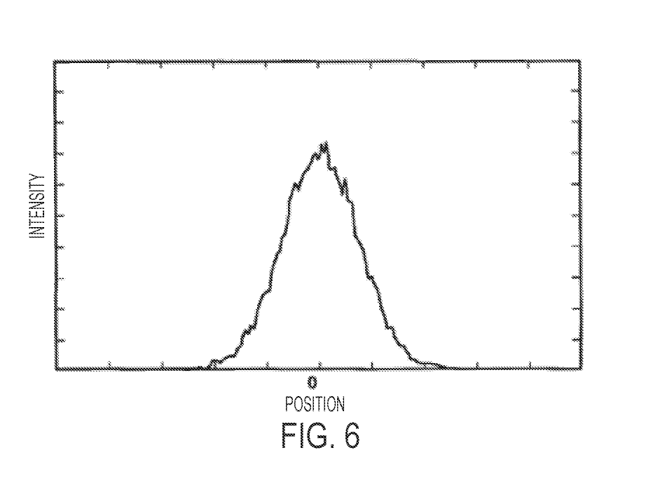

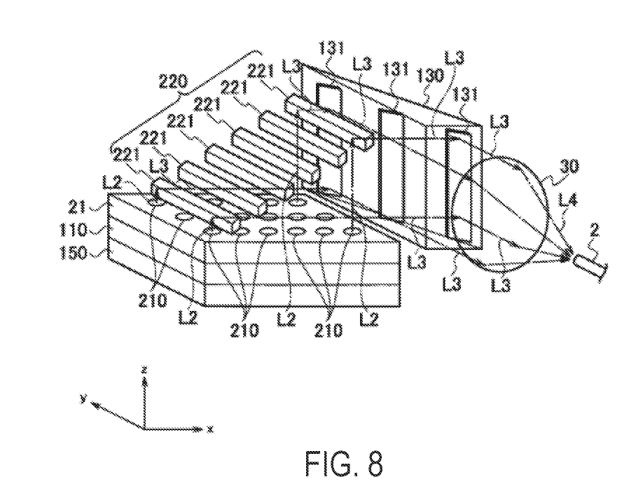

FIG. 5 shows data on the output lights of a comparative example wherein the collimated beams are focused without the beam diameters being enlarged. Moreover, FIG. 6 shows data for the output lights L4 of the light-emitting device 1 wherein the focusing was after the beam diameters of the collimated beams L2 were enlarged. The horizontal axes in FIG. 5 and FIG. 6 are the distances from the beam center, and the vertical axes are the intensities at each of the positions. As can be appreciated from a comparison of FIG. 6 and FIG. 8, in the ones wherein the beam diameters have been enlarged, the spreads of the beam diameters are less.

In the above, an example is given wherein the light-outputting device 20 is provided with diffraction gratings 22 for enlarging the beam diameters in the direction wherein the diameters are small in the collimated beams L2. However, other devices having the effect of enlarging the beam diameters, such as a prism, or the like, may be used instead of the diffraction gratings 22. Note that preferably the beam diameters are enlarged so that the shapes of the advancing faces of the enlarged beams L3 are as close as possible to being perfect circles.

As explained above, in the light-emitting device 1 according to the first embodiment according to the present invention, each collimated beam L2 has the beam diameter thereof enlarged in the direction in which the beam diameter is small. Because of this, the optical magnification rate in the light-emitting device 1 is set so as to be small. Consequently, with the light-emitting device 1, the focusing performance is improved and the focusing spot size is reduced, enabling an improvement in the brightness of the outputted lights L4. Because of this, it is possible to improve the focusing performance even when an increase in power is achieved through enlarging the sizes in the direction wherein the emitter size is large.

As described above, given the light-emitting device 1, it is possible to produce a light-emitting device wherein the power is increased through combining light from a plurality of light sources 10, and wherein the focusing performance is improved.

The light-emitting device 1 is particularly effective for light sources 10 wherein the beam shape in the cross-sectional direction that is perpendicular to the optical axis is elliptical, such as when there is a large difference between the beam diameter in the first axial direction and the beam diameter in the slow axial direction.

A plurality of light sources that emit light of mutually differing wavelengths may be combined as the light sources 10 of the light-emitting device 1. This enables multi-coloration of the output lights L4.

### Modified Example

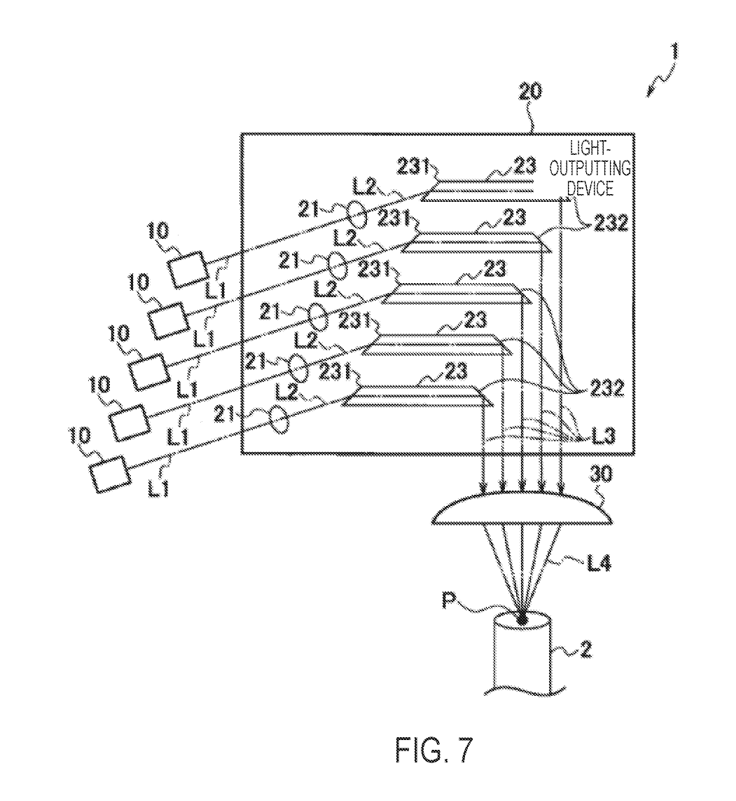

As far as described above, prisms may be used instead of the diffraction gratings 22 to enlarge the beam diameters. FIG. 7 illustrates a case wherein the light-outputting device 20 has prisms 23 for enlarging the beam diameters of the collimated beams L2 in order to output enlarged beams L3. The collimated beams L2 are introduced into the prisms 23 from the incident faces 231. In this case, the appropriate selections of the incident angles between the collimated beams L2 and the prisms 23 enable enlargement of a single direction (the short axial direction) of the elliptical shape. Because of this, for the collimated beams L2, the beam diameters can be enlarged in the direction in which the beam diameters are small.

Moreover, the directions of advancement of the enlarged beams L3 that are outputted from the prisms 23 can be set through adjusting, for example, the angles of the emitting faces 232 of the prisms 23. In the example illustrated in FIG. 7, the directions of advancement of the lights that propagate within the prisms 23 are changed by 90° at the emitting faces 232 of the prisms 23, for the enlarged beams L3 to be outputted from the prisms 23. In this way, the prisms 23 function as a means for shaping the beams of the collimated beams L2, and as propagation paths.

Moreover, the positions of the prisms 23 or the angles of emission of the enlarged beams L3 can be adjusted so that the distances between adjacent enlarged beams L3 will be less than the distances between the light sources 10. The makes it possible to improve the focusing performance of the outputted lights L4. For example, this makes it possible to narrow the range of over which the plurality of enlarged beams L3 that are outputted from the light-outputting device 20 are arranged in a direction perpendicular to the advancing direction so as to be narrower than the area of the region wherein the light sources 10 are arranged, to output, to the focusing devices 30, a plurality of enlarged beams L3 wherein the density has been increased.

### Second Embodiment

The above was an explanation regarding a light-emitting device 1 wherein a plurality of light sources 10 was arranged in a one-dimensional array. The below will be an explanation for a light-emitting device 1 wherein a plurality of light sources 10 is arranged two-dimensionally. Note that the plane wherein the light sources 10 are arranged two-dimensionally is defined as the xy plane. The direction that is normal to the xy plane is defined as the z direction.

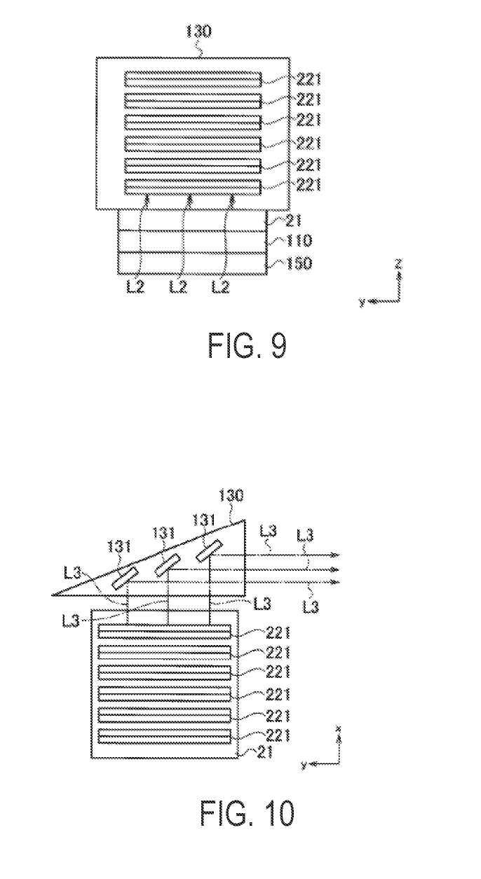

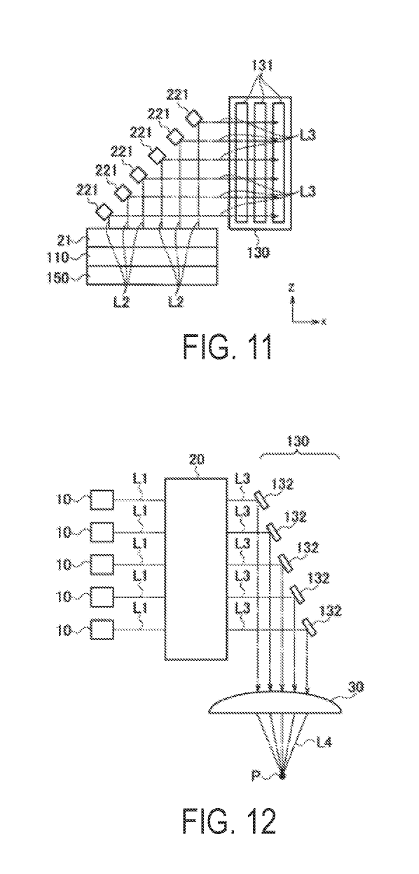

Although omitted from the drawings, the light sources 10 are arranged in two dimensions in the LD mount 110 illustrated in FIG. 8 through FIG. 11. The collimating devices 21 is disposed on the top face of the LD mount 110. The collimating device 21, illustrated in FIG. 8, is a lens array wherein collimating lenses 210 are arrayed in two dimensions in the xy plane in a one-to-one correspondence facing the light sources 10 that are arranged in two dimensions on the LD mount 110. Moreover, a heat dissipating portion 150, for dissipating, to the outside, the heat that is produced in the LD mount 110, is disposed on the bottom face of the LD mount 110.

A diffraction grating array 220 is disposed in the z direction of the collimating device 21. In the diffraction grating array 220, a plurality of diffraction gratings 221 wherein each extends in one direction of the xy plane wherein the collimating lenses 210 are disposed (for example, the y direction in FIG. 8) is disposed along the other direction (the x direction in FIG. 8) of the xy plane. The number of diffraction gratings 221 is the same as the number of collimating lenses 210 in the x direction. That is, for the collimated beams L2 that are incident onto the diffraction grating array 220 that is in a form wherein diffraction gratings 221 are arranged in two dimensions in the xy plane, one is prepared for each position of the collimating lenses 210 in the x direction.

One row worth of collimated beams L2 that are lined up in the y direction are all incident on the same diffraction grating 221. Given this, one row worth of enlarged beams L3 in the y direction are outputted to identical heights in the z direction from the individual diffraction gratings 221. Here the enlarged beams L3 are, for example, the first-order diffracted lights. The enlarged beams L3 are incident onto the collimating devices 21 and the changing devices 130 that are disposed in the x direction of the diffraction grating array 220. The changing device 130 changes the directions in which the enlarged beams L3 advance.

As described above, in the light-emitting device 1 illustrated in FIG. 8 through FIG. 11, the light-outputting device 20 is equipped with a collimating device 21 wherein collimating lenses 210 are arranged in two dimensions, a diffraction grating array 220 wherein diffraction gratings 221 each extend in the y direction is disposed in the x direction, and a changing device 130.

As illustrated in FIG. 8, the diffraction gratings 221 are each at different distances along the z direction from the collimating device 21. Because of this, each of the enlarged beams L3, which have the same positions in the x direction, is incident into the changing device 130 that is arranged along the z direction. That is, the array of light sources 10 in the x direction is converted into an array of enlarged beams L3 in the z direction.

Here the changing device 130 is a mirror array. Specifically, a plurality of mirrors 131 extends in the z direction, corresponding to the y-direction positions with which the collimating lenses 210 of the lens array are arranged. That is, the enlarged beams L3 that are at identical directions in the y direction are incident onto identical mirrors 131. The mirrors 131 are arranged at different positions in the x direction. Because of this, as illustrated in FIG. 8, and the like, the array of light sources 10 in the y direction is converted into an array of enlarged beams L3 in the x direction.

Consequently, the array of light sources 10 in the xy plane (which is, for example, the horizontal plane) is converted into an array of enlarged beams L3 in the xz plane (for example, the vertical direction) that is perpendicular to the xy plane. That is, a plurality of enlarged beams L3 is outputted in the direction that is normal to a plane that is perpendicular to the plane wherein the plurality of light sources 10 is arranged. In other words, in the light-emitting device 1 illustrated in FIG. 8, and the like, the direction in which the light L1 that is emitted from the light source 10 advances is shifted perpendicularly, and after integration, the enlarged beams L3 are integrated together.

The range over which the direction in which the enlarged beams L3, which are outputted from the light-outputting device 20, advance is set through the setting the z-direction spacing of the diffraction gratings 221, and setting the x direction spacing of the mirrors 131 in the changing device 130. Consequently, the area of the range over which the direction of advancement of the plurality of enlarged beams L3 that are outputted from the light-outputting device 20 is arranged can be made narrower than the region over which the light sources 10 are arranged, through adjusting the range over which the diffraction gratings 221 are arranged and the range over which the mirrors 131 in the changing device 130 are arranged so as to be narrow.

Given the light-emitting device 1 according to the second embodiment, as described above, after the area of the range over which the directions in which the enlarged beams L3, which are outputted from the light-outputting device 20, advance are arranged is caused to be narrower than the area of the region over which the plurality of light sources 10 is arranged in two dimensions, the enlarged beams L3 are focused by the focusing devices 30. Consequently, the lights from the plurality of light sources 10 that are arrayed in two dimensions can be strengthened through combination while the focusing performance can be improved as well.

Note that while in the above an example was given wherein the collimated beams L2 were changed into enlarged beams L3 by a diffraction grating array 220, obviously an array of prisms may be used instead of diffraction gratings.

### Modified Example

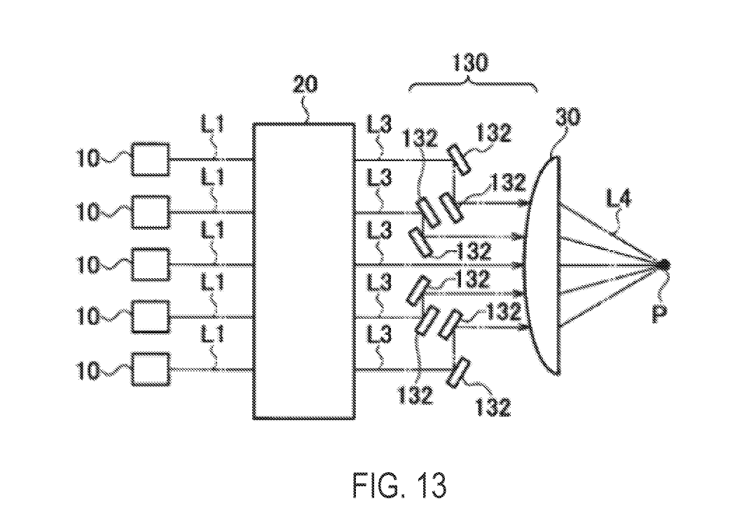

In FIG. 8 through FIG. 11, the way in which the enlarged beams L3 advance was changed through a mirror array in the light-outputting device 20. On the other hand, the direction in which the enlarged beams L3 advance may instead be changed through a changing device 130 of another structure, as in the light-emitting device 1 illustrated in FIG. 12 and FIG. 13.

FIG. 12 is an example wherein the changing device 130 has a plurality of changing elements 132 into which the respective enlarged beams L3 of a plurality thereof are incident. The direction in which the enlarged beams L3, which progress in the crosswise direction of FIG. 12, advance is changed perpendicularly to the vertical direction in FIG. 12 by the changing elements 132. Mirrors, for example, may be employed for each of the changing elements 132. FIG. 12 is an example wherein a stepped mirror is used for the changing device 130.

Note that the distances between the enlarged beams L3 that are incident into the focusing devices 30 can be made narrower than the distances between the light sources 10 by having the crosswise-direction distances between adjacent changing elements 132 be narrower than the distances between neighboring enlarged beams L3. The focusing performance is improved thereby.

FIG. 13 is an example wherein the direction of advancement of the enlarged beams L3 is changed through mirror pairs comprising two changing elements 132. By, for example, changing twice, at right angles, the directions in which the enlarged beams L3 advance, the directions in which the enlarged beams L3 advance can be changed to the same directions as the directions in which the emitted lights L1 from the light sources 10 advance. That is, the enlarged beams L3 can be focused in the direction in which the emitted lights L1 advance.

Examples wherein the changing device 130 is a mirror array, a stepped mirror, and a mirror pair have been given above. However, insofar as there is the effect of changing the direction in which the beams advance, other devices may also be employed for the changing device 130. For example, prisms or diffraction gratings, or the like, may also be used for the changing device 130.

### Third Embodiment

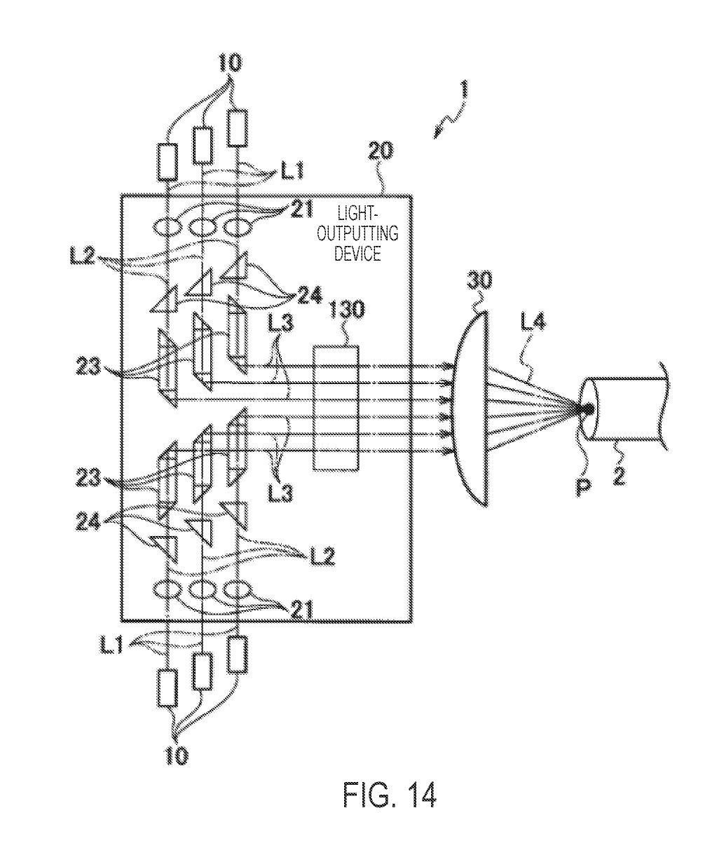

As illustrated in FIG. 14, enlarging prisms 24 for spreading the beam diameters of the collimated beams L2 may be disposed between the collimating devices 21 and the prisms 23. The enlarging prisms 24 enlarge the beam diameters of the collimated beams L2 prior to the collimated beams L2 having the beam diameters thereof enlarged by the diffraction gratings 22 to output the enlarged beams L3. This can increase the optical magnification rate performance of the light-emitting device 1 as a whole. Note that the positions of the prisms 23 and the angles with which the enlarged beams L3 are emitted can be adjusted in order to reduce the beam spacing of the enlarged beams L3 to less than the distance between the light sources 10. This makes it possible to improve the focusing performance of the outputted lights L4 by narrowing the spacing of the enlarged beams L3 in the horizontal direction.

Moreover, as illustrated in FIG. 14, the enlarged beams L3 that are outputted from the prisms 23 may be inputted into the focusing device 30 after passing through the changing device 130. The spacing of the beams in the direction perpendicular to the enlarged beams L3, when the light sources 10 are arranged in two dimensions, can be reduced by the changing device 130. This enables a further improvement in the focusing performance. Beam steering prisms, or the like, may be employed for the changing device 130 in FIG. 14.

Even when diffraction gratings 22 are used instead of the prisms 23, disposing enlarging prisms 24 between the collimating devices 21 and the diffraction gratings 22 makes it possible to produce the same effects as when disposing enlarging prisms 24 between the collimating devices 21 and the diffraction gratings 22. Moreover, the same is true even when even when collimating lenses 210 that are arranged in two dimensions are used in the collimating device 21, as illustrated in FIG. 8. That is, the collimated beams L2 may be inputted into diffraction gratings 22 or prisms 23 after the beam diameters have been expanded by respective enlarging prisms 24 for the collimated beams L2 from the collimating lenses 210.

### Another Embodiment

While the present invention has been explained using embodiments as described above, it should be understood that the descriptions and drawings that comprise a portion of the present disclosure do not limit the invention. From this disclosure, a variety of other embodiments, examples, and operating technologies will be obvious to those skilled in the art.

In the explanations of the embodiments that have already been described above, examples were given wherein the light-outputting device 20 was provided with collimating lenses and diffraction gratings, but diffraction gratings having collimating functions may be used instead.

Moreover, FIG. 1 shows an example wherein, in a light-emitting device 1 wherein light sources 10 are arrayed in one dimension, the directions in which the enlarged beams L3 advance are changed by the diffraction gratings 22. However, the directions in which the enlarged beams L3 advance can be changed by the changing device 130, as in the light-emitting device 1 illustrated in FIG. 12 and FIG. 13. This makes it possible to output the outputted lights L4 in the desired directions even when the light sources 10 are arrayed in one dimension. For example, the enlarged beams L3 can be focused in the directions in which the emitted lights L1 advance from the light source 10.

In this way, the present invention includes, of course, a variety of embodiments, and the like, not described here. Consequently, the scope of technology of the present invention is determined by the items that specify the inventions according to the applicable patent claims, from the explanations above.

### EXPLANATIONS OF REFERENCE SYMBOLS

1: Light-Emitting Device
2: Light-Receiving Device
10: Light Source
20: Light-Outputting Device
21: Collimating Device
22: Diffraction Grating
23: Prism
24: Enlarging Prism
30: Focusing Device
110: LD Mount
130: Changing Device
131: Mirror
132: Changing Element
150: Heat Dissipating Portion
210: Collimating Lens
220: Diffraction Grating Array
221: Diffraction Grating
S: Slow Axial Direction
F: First Axial Direction
L1: Emitted Light
L2: Collimated Beam
L3: Enlarged Beams
L4: Outputted Light

What is claimed:

1. A light-emitting device comprising:
a plurality of light sources;
a light-outputting device for generating collimated beams for respective emitted lights from the plurality of light sources and for outputting enlarged beams wherein the beam diameters have been enlarged in the direction in which the beam diameters are small, for the respective collimated beams; and
a focusing device for focusing the enlarged beams.

2. A light-emitting device as set forth in claim 1, wherein:
the light-outputting device comprises: a collimating device for collimating, to generate collimated beams, the respective lights emitted from the plurality of light sources; and diffraction gratings for outputting diffracted light as enlarged beams of the respective generated collimated beams; wherein
the number of grooves in the diffraction grating, and the angles of incidence of the collimated beams of the diffraction gratings, are set so as to enlarge the beam diameters of the collimated beams in the direction in which the beam diameters are small.

3. A light-emitting device as set forth in claim 2, wherein:
the enlarged beam is the first-order diffracted light of the diffracted light.

4. A light-emitting device as set forth in claim 2, wherein:
a portion of the diffracted light is returned to the light source.

5. A light-emitting device as set forth in claim 1, wherein:
the light-outputting device comprises a collimating device for generating collimated beams by collimating the respective emitted lights from a plurality of light sources; and
a prism for outputting enlarged beams by enlarging the beam diameters of the respective generated collimated beams.

6. A light-emitting device as set forth in any one of claim 1, wherein:
a plurality of light sources is arrayed in two dimensions; and
the light-outputting device outputs, to the focusing devices, a plurality of enlarged beams after narrowing the area of the range over which the plurality of enlarged beams that are outputted from the light-outputting device are arranged in the advancing direction to less than the area of the region wherein the plurality of light sources is arranged.

7. A light-emitting device as set forth in claim 6, wherein:
the plurality of enlarged beams is outputted in a direction normal to a plane that is perpendicular to the plane in which the plurality of light sources is arranged.

8. A light-emitting device as set forth in any one of claim 1, further comprising:
a changing device for changing a direction in which the enlarged beams advance.

9. A light-emitting device as set forth in claim 8, wherein:
the changing device changes the directions in which the enlarged beams advance to the same directions as the direction in which the emitted lights from the light source advance.

10. A light-emitting device as set forth in any one of claim 1, wherein:
the plurality of light sources include light sources that emit light at mutually differing wavelengths.
